(19) United States
(12) Patent Application Publication
(10) Pub. No.: US 2026/0278347 A1
(43) Pub. Date: Sep. 17, 2026

(54) MITIGATING HALLUCINATIONS IN ARTIFICIAL INTELLIGENCE CHATBOTS

(71) Applicant: International Business Machines Corporation, Armonk, NY (US)

(72) Inventors: Bo Wen, Chappaqua, NY (US); Chen Wang, Chappaqua, NY (US); Huamin Chen, Newton, MA (US); Mark Wegman, Mt. Kisco, NY (US)

(21) Appl. No.: 19/078,396

(22) Filed: Mar. 13, 2025

(51) Int. Cl. G06N 3/0475; G06N 3/092

(52) U.S. Cl. CPC G06N 3/0475; G06N 3/092

(57) ABSTRACT

Examples described herein provide systems and methods for mitigating hallucinations in artificial intelligence chatbots. Aspects include receiving a prompt from a user, generating, in response to the prompt, an output by a thought generator, where the thought generator is configured to utilize one or more large language models to generate the output, and calculating, by a thought assessor, a confidence score for the output. Aspects also include performing a supplemental review of the prompt and the output, where the supplemental review determines whether the output includes a hallucination, based on a determination that the confidence score of the output does not exceed a threshold value and based on a determination that the output includes the hallucination, fine-tuning the thought generator.

### BACKGROUND

The disclosure relates to artificial intelligence technologies, specifically to methods and systems for reducing hallucinations in artificial intelligence (AI) chatbots using a multi-agent language model approach.

In recent years, the deployment of large language models (LLMs) in medical dialogue systems has gained significant attention due to their potential to enhance patient care and streamline healthcare communication. However, a challenge persists in the form of hallucinations, where these AI systems generate unfounded or inconsistent information. Such inaccuracies can be particularly dangerous in healthcare applications, where incorrect medical advice could jeopardize patient safety. Existing solutions often focus on modifying training data or inference procedures, yet these approaches have not fully addressed the issue of hallucinations, leaving a gap in ensuring the reliability and safety of medical dialogue systems.

Current methods, such as retrieval-augmented generation and reinforcement learning from human feedback, have been explored to mitigate hallucinations. However, these techniques typically rely on frameworks that may not adequately capture the complexity and variability of medical dialogues. Moreover, while some systems attempt to ground responses in external knowledge bases, they still face challenges in maintaining consistency and accuracy across diverse medical scenarios. As the demand for trustworthy AI in healthcare continues to grow, there is a pressing need for innovative approaches that can effectively reduce hallucinations and enhance the dependability of medical dialogue chatbots.

### SUMMARY

According to one aspect of the present invention, a computer-implemented method for mitigating hallucinations in artificial intelligence chatbots is provided. The method includes receiving a prompt from a user, generating, in response to the prompt, an output by a thought generator, where the thought generator is configured to utilize one or more large language models to generate the output, and calculating, by a thought assessor, a confidence score for the output. The method also includes performing a supplemental review of the prompt and the output, where the supplemental review determines whether the output includes a hallucination, based on a determination that the confidence score of the output does not exceed a threshold value and based on a determination that the output includes the hallucination, fine-tuning the thought generator.

The above features and advantages, and other features and advantages, of the disclosure, are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 is a block diagram illustrating a computing environment, according to one or more embodiments;

FIG. 2 is a block diagram illustrating a system for mitigating hallucinations in AI chatbots according to one or more embodiments;

FIG. 3 is a flow chart diagram illustrating a method for mitigating hallucinations in AI chatbot, according to one or more embodiments;

FIG. 4 is a flow chart diagram illustrating a method for evaluating a response generated by an LLM for hallucinations, according to one or more embodiments; and

FIG. 5 is a flow chart diagram illustrating a method for method for mitigating hallucinations in AI chatbot, according to one or more embodiments.

The detailed description explains embodiments of the disclosure, together with advantages and features, by way of example with reference to the drawings.

### DETAILED DESCRIPTION

In recent years, the deployment of LLMs in medical dialogue systems has gained significant attention due to their potential to enhance patient care and streamline healthcare communication. However, a persistent challenge in this domain is the phenomenon of hallucinations, where AI systems generate unfounded or inconsistent information. Such inaccuracies can be particularly dangerous in healthcare applications, where incorrect medical advice could jeopardize patient safety. The reliability and safety of medical dialogue systems are thus a major concern, necessitating innovative solutions to mitigate these risks.

Existing solutions to address hallucinations in AI chatbots often focus on modifying training data or inference procedures. Techniques such as retrieval-augmented generation and reinforcement learning from human feedback have been explored. However, these approaches typically rely on frameworks that may not adequately capture the complexity and variability of medical dialogues. Moreover, while some systems attempt to ground responses in external knowledge bases, they still face challenges in maintaining consistency and accuracy across diverse medical scenarios. As the demand for trustworthy AI in healthcare continues to grow, there is a pressing need for approaches that can effectively reduce hallucinations and enhance the dependability of medical dialogue chatbots.

The present system introduces a novel multi-agent framework designed to address the significant issue of hallucinations in LLMs used for medical dialogue chatbots. This framework includes a thought generator, a thought assessor, and a steering subsystem, which collectively work to detect and mitigate hallucinations in real-time. The thought generator produces responses, while the thought assessor evaluates their medical validity and consistency. The steering subsystem incorporates human feedback to iteratively refine the models, thereby enhancing the safety and reliability of medical dialogue chatbots. This structured approach not only reduces hallucinations but also enables continuous improvement of the framework based on expert input, ensuring that the chatbot provides accurate and trustworthy medical advice.

Descriptions of various embodiments of the present disclosure are presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

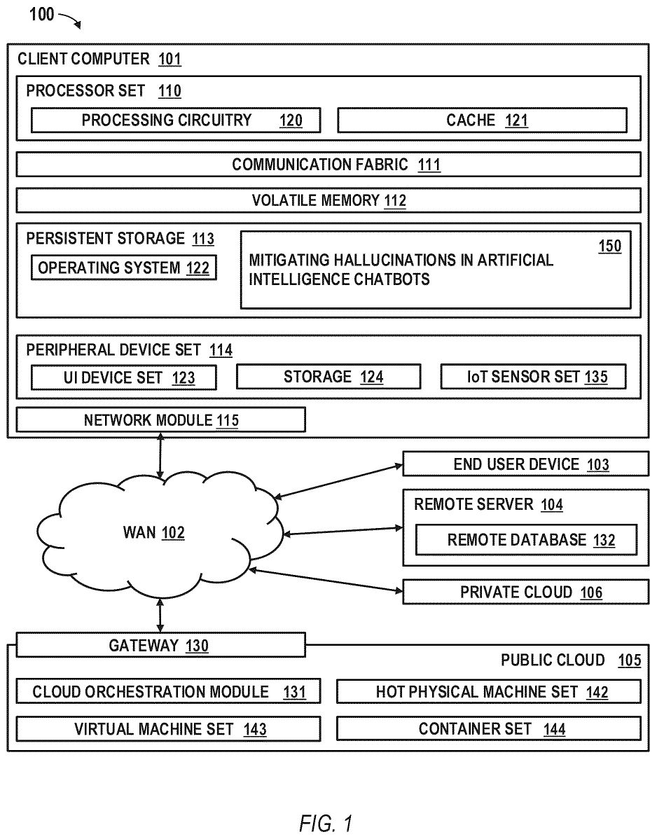

FIG. 1 illustrates a computing environment 100, according to an embodiment. Computing environment 100 contains an example of an environment for the execution of at least some of the computer code includes mitigating hallucinations in artificial intelligence chatbots, as shown at block 150. In addition to a controller for controlling the operations of a metal cutting tool, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122, as identified above), peripheral device set 114 (including user interface (UI) device set 123, storage 124, and Internet of Things (IoT) sensor set 135), and network module 115. Remote server 104 includes remote database 132. Public cloud 105 includes gateway 130, cloud orchestration module 131, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 132. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in persistent storage 113 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 135 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 132 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 131. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 131 manages the transfer and storage of images, deploys new instantiations of VCEs and manages active instantiations of VCE deployments. Gateway 130 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to one or more embodiments, the computing environment 100 can provide remote data storage. For example, the computer 101 can be a cloud storage system or other suitable system for storing data that is accessible to a user remotely, such as by accessing the computer 101 using the end user device 103. That is, a user can send a user operation (also referred to as a “user request”) from the end user device 103 to the computer 101 via the WAN 102. Although the user operation may appear to be simple, such as uploading an object to a cloud storage system, the complications of operating a cloud computing system often have side effects and produce ancillary data, which may be consumed by both the operator of the system (e.g., the computer 101) and by users or other components of the cloud architecture (e.g., the computing environment 100). Ancillary data may be created by user operations that trigger the creation of the ancillary data. Ancillary data may be resource consumption information, notification data, and/or the like, including combinations and/or multiples thereof. Data for an independent event may be inferred from another event (e.g., event to update resource consumption information for an entity in a system also means that the total consumption information for the owner of the entity is also updated).

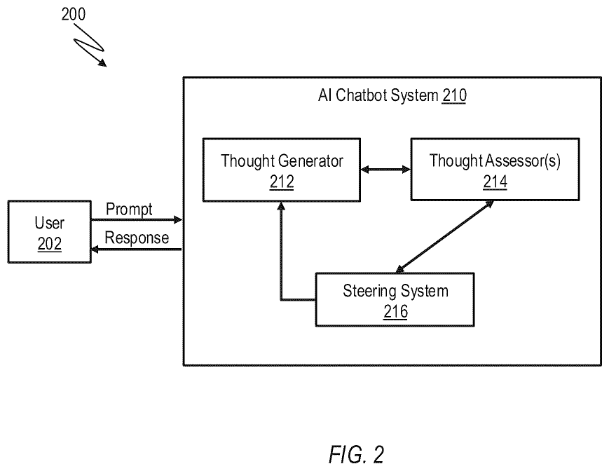

Referring now to FIG. 2, a block diagram illustrating a system 200 for mitigating hallucinations in AI chatbots in accordance with an embodiment is shown. The system includes a user 202 that interacts with an AI chatbot system 210. In exemplary embodiments, the AI chatbot system 210 may be a specialty chatbot system that has been trained in a particular field, such as a medical AI chatbot.

In exemplary embodiments, the user 202 provides input, typically in the form of a query or prompt, which is then processed by the AI chatbot system 210. This interaction establishes the context for the subsequent operations of the system 200. In exemplary embodiments, the user 202 can be a patient, healthcare provider, or any individual seeking information or assistance from the chatbot. The input from the user 202 is directed to the thought generator 212, which is responsible for generating a response based on the input received.

In exemplary embodiments, the AI chatbot system 210 functions as the comprehensive framework that includes the thought generator 212, thought assessor 214, and steering system 216. The AI chatbot system 210 is designed to handle user inputs, process them through the internal components, and deliver a coherent and accurate response back to the user 202. The AI chatbot system 210 is configured to reduce hallucinations in AI-generated responses, especially in sensitive domains like medical dialogue, by leveraging a multi-agent architecture.

In exemplary embodiments, the thought generator 212 is configured to generate initial responses to user inputs. The thought generator 212 utilizes large language models (LLMs) to generate continuations or completions based on the input provided by the user 202. The thought generator 212 is designed to work in conjunction with the thought assessor 214, which evaluates the generated output for accuracy and consistency. The thought generator 212 can be implemented using various configurations, such as a single LLM or a network of LLMs, to enhance response generation capabilities. The primary function of the thought generator 212 is to provide an initial response that is then scrutinized by the thought assessor 214 for potential hallucinations.

In exemplary embodiments, the thought assessor 214 is configured to ensure the reliability of the responses generated by the thought generator 212. The thought assessor 214 evaluates the validity and consistency of the output, using multiple heuristics such as sequence log-probability, attention to contradictory tokens, and dissimilarity of Monte Carlo samples. The thought assessor 214 is configured to calculate a confidence score for the generated response. If the confidence is below a predetermined threshold, the thought assessor 214 flags the response for further review, potentially involving human experts. This mechanism helps in identifying and mitigating hallucinations in responses generated by the thought generator 212, thereby enhancing the trustworthiness of the AI chatbot system 210.

In exemplary embodiments, the steering system 216 is configured to receive feedback and responsively fine-tunes the operations of the thought generator 212 and thought assessor 214. The steering system 216 functions as a feedback loop that utilizes human evaluations and expert reviews to enhance the performance of the AI chatbot system 210 over time. The steering system 216 captures interactions where the thought assessor 214 has flagged low confidence outputs and uses this information to adjust the models utilized by the thought generator 212, ensuring that similar issues are handled more effectively in the future. The steering system 216 is configured to enable the continuous improvement and adaptation of the AI chatbot system 210, allowing the system to provide more accurate and reliable responses in dynamic and complex scenarios.

In one embodiment, the system 200 is implemented as a medical dialogue chatbot designed to provide information about diabetes management. The thought generator 212 includes an LLM that is fine-tuned on various sources, encompassing diabetes symptoms, monitoring, treatment, and lifestyle factors. Concurrently, the thought assessor 214 is trained using both these authoritative sources and examples of common misconceptions and misinformation related to diabetes. During operation, when a user 202 inquires about the safety of a specific food item for diabetics, the thought generator 212 formulates a response. The thought assessor 214 then evaluates this response, ensuring its consistency with official dietary guidelines for diabetes management. Should the generated response contain claims that contradict these guidelines or make unsupported assertions, the thought assessor 214 flags such statements as potential hallucinations. Subsequently, the flagged response is presented to a diabetes specialist for verification. If the specialist identifies inaccuracies within the response, the steering system 216 records this feedback. The AI chatbot system 210 then updates the thought generator 212 to minimize the recurrence of such inaccuracies in similar future contexts. In addition, the thought assessor 214 may be refined to enhance its sensitivity to these types of errors. Through numerous user interactions, this iterative process fosters a continuously improving system, delivering increasingly reliable and safe information to diabetic patients.

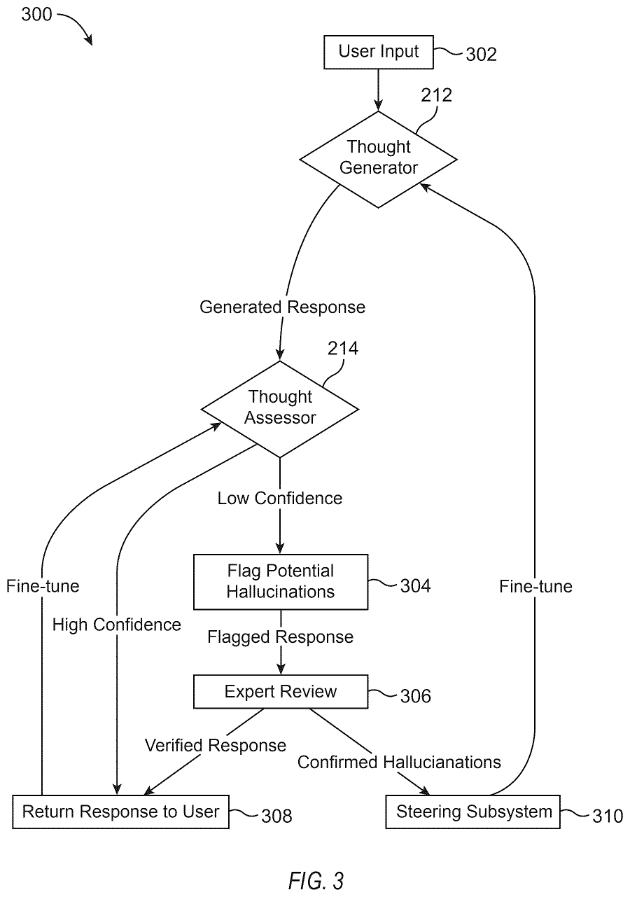

FIG. 3 shows a method 300 for mitigating hallucinations in AI chatbots, according to one or more embodiments. The method 300 is implemented by a system that includes a thought generator 212 and a thought assessor 214, as depicted in FIG. 2. The method 300 begins with user input 302 and proceeds through various stages to ensure the reliability and accuracy of the AI-generated responses that are provided to the user.

The method 300 begins with receiving user input 302. This input is typically a query or prompt provided by the user, which sets the context for the subsequent operations of the system. In exemplary embodiments, one or more context documents may be provided along with the prompt. For example, the prompt may be a request for a suggested treatment for a patient and the context documents may include medical records of the patient. Next, the thought generator 212 processes the user input 302, and any context documents provided, to generate a response. In exemplary embodiments, the thought generator 212 utilizes one or more LLMs to create an initial response based on the input provided by the user. In exemplary embodiments, the LLMs may be fine-tuned on a specific technical field, such as medical knowledge.

Once the thought generator 212 generates the response, it is provided to the thought assessor 214 for evaluation. In exemplary embodiments, the thought assessor 214 assesses the generated response for accuracy and consistency and the thought assessor 214 calculates a confidence score for the generated response. If the confidence score is high, the method proceeds to block 308 and the response is returned to the user. If the thought assessor 214 determines that the confidence score is low, the method 300 proceeds to block 304 and the response is flagged as having a potential hallucination.

Next, as shown at block 306, the flagged response is subject to further review to assess the accuracy of the generated response. In one embodiment, the further review includes providing the prompt, context documents, and the generated response to an expert to confirm or deny the presence of any hallucinations. In an alternative embodiment, when a response is flagged for potential hallucinations, it undergoes further review using specialized LLMs that are more resource-intensive and slower to operate than the thought generator 212. These specialty LLMs are designed to provide a deeper analysis and verification of the flagged response, ensuring a higher level of accuracy and reliability. For example, the specialty LLM may be provided the original user prompt, any relevant context documents, and the flagged response and it conducts a detailed contextual analysis, cross-referencing the response with authoritative medical sources and databases to verify its accuracy and consistency. The specialty LLM can employ advanced heuristics and algorithms that are not feasible for real-time processing due to their computational intensity. These may include deep semantic analysis, cross-validation with multiple medical ontologies, and the use of ensemble techniques to aggregate insights from various sub-models. In exemplary embodiments, the specialty LLM recalculates the confidence score of the response, taking into account the additional layers of analysis. This reassessment provides a more nuanced understanding of the response's validity, identifying any subtle inconsistencies or unsupported claims that the initial thought assessor might have missed. In some cases, the specialty LLM may be integrated with an expert system that simulates the decision-making process of a human medical expert, providing recommendations or highlighting areas of concern that require human intervention.

If the further review of the flagged response at block 306 indicates that the response was correct, i.e., that the response did not include a hallucination, the method 300 proceeds to block 308 and the response is provided to the user. In addition, the feedback from the supplemental review of the response is used to fine-tune the thought assessor 214, as the thought assessor 214 incorrectly flagged the generated response as including a hallucination. However, if the further review of the flagged response at block 306 indicates that the response was not correct, i.e., that the response did include a hallucination, the method 300 proceeds to block 310 and the response is provided to the steering system. In addition, the feedback from the supplemental review of the response is used to fine-tune the thought generator 212, as the thought generator 212 generated a response that included a hallucination. In exemplary embodiments, this continuous feedback loop helps improve the overall performance of the AI chatbot system, reducing the likelihood of similar hallucinations in future interactions.

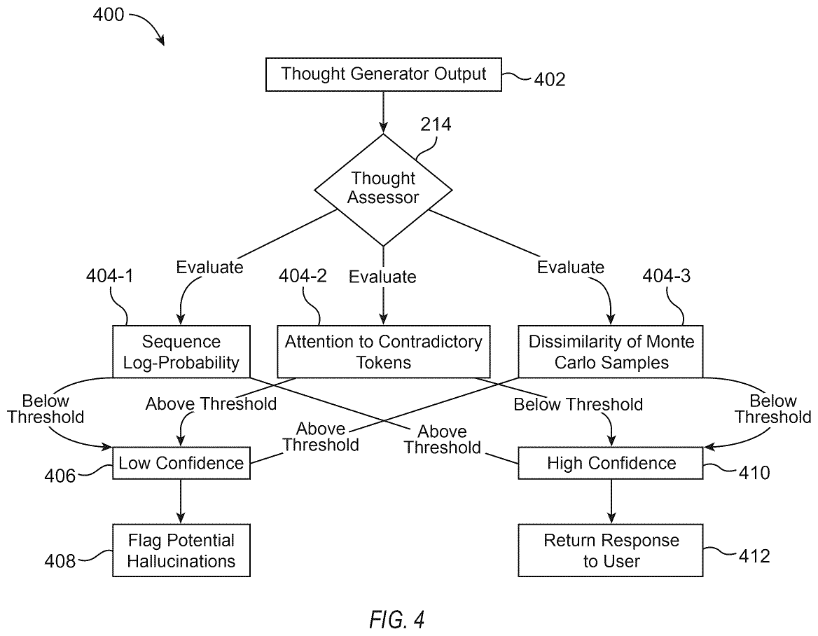

FIG. 4 illustrates a method 400 for evaluating the confidence of responses generated by an AI chatbot system, according to one or more embodiments. The method 400 is implemented by a system that includes a thought generator 212 and a thought assessor 214, as depicted in FIG. 2. The process begins with a thought generator output 402 being provided to a thought assessor 214.

In exemplary embodiments, the thought generator output 402 is a comprehensive data package provided to the thought assessor 214 for evaluation, encompassing several components that collectively enable a detailed analysis of the generated response's accuracy and consistency. The thought generator output 402 includes the original input prompt provided by the user, which sets the context for the response generation process and serves as the foundational query or request that the AI system aims to address. The thought generator output 402 also includes the internal states of the thought generator 212. These internal states include log probabilities, which represent the likelihood of each token in the generated sequence given the input and the model's parameters, providing insight into the thought generator 212 model's confidence in its token-level predictions. Attention weights are also included, indicating the focus of the model on different parts of the input prompt and context documents during the generation process, helping to identify which tokens or phrases the model considered most relevant when forming the response. Additionally, hidden states are part of the output, reflecting the intermediate representations within the model that capture the contextual information and semantic understanding of the input, offering a deeper layer of analysis into the model's internal processing and decision-making.

In exemplary embodiments, the thought generator output 402 also includes the actual response generated by the thought generator, which is the direct result of processing the input prompt and any associated context documents. This generated output is the primary subject of evaluation by the thought assessor, as it needs to be checked for accuracy, consistency, and potential hallucinations. If any context documents were provided along with the input prompt, they are included in the thought generator output 402, offering additional information and background that can influence the response generation. These context documents are used by the thought assessor 214 to verify the consistency and relevance of the generated output about the provided context. By incorporating these components, the thought generator output 402 equips the thought assessor 214 with a comprehensive dataset necessary for a thorough evaluation, allowing the application of various heuristics and metrics to calculate a confidence score, ensuring that the AI system delivers accurate and reliable responses to the user.

In exemplary embodiments, the thought generator output 402 is evaluated by the thought assessor 214 using multiple heuristics. These heuristics are designed to identify potential inaccuracies or inconsistencies in the output, ensuring that only reliable information is delivered to the user.

In exemplary embodiments, a first heuristic 404-1 is a Sequence Log-Probability, measures the language model's confidence in its generated output by calculating the likelihood of the sequence given the input and model parameters. If the sequence log-probability falls below a predetermined threshold, it indicates low confidence. In one example, the thought assessor 214 calculates the sequence log-probability of the generated response. This metric measures the language model's confidence in its output by evaluating the likelihood of the sequence given the input and the model's parameters. The formula used is:

$$Seq = Log prob = \frac{1}{L} {\sum }_{k = 1}^{L} log P ( yk \vert y < k , x , θ )$$

where L is the length of the output, yₖ is the k-th token in the output sequence, y_{<k} represents the preceding tokens, x is the input, and θ denotes the model parameters. A higher Seq-Logprob indicates greater confidence in the response.

In exemplary embodiments, a second heuristic 404-2 is an Attention to Contradictory Tokens, assesses the degree to which the language model attends to tokens that contradict the current output. High attention to contradictory tokens suggests uncertainty, and if this attention exceeds a threshold, it signals low confidence.

In exemplary embodiments, a third heuristic 404-3 is a Dissimilarity of Monte Carlo Samples, involves generating multiple output samples using Monte Carlo dropout during inference. The dissimilarity between these samples is computed using metrics such as METEOR or BERTScore. High dissimilarity indicates the model is uncertain and may be hallucinating. If the average dissimilarity exceeds a threshold, it suggests low confidence.

In exemplary embodiments, if any of these heuristics 404-1, 404-2, 404-3 detect low confidence, the method proceeds to block 406, where a low confidence score is assigned to the generated response. Next, as shown at block 408, the response is flagged for potential hallucinations. Conversely, if the thought assessor 214 determines that the confidence score is high across all heuristics, the method proceeds to block 410 where a high confidence score is assigned to the generated response. Next, as shown at block 412 the response is considered reliable and returned to the user. By employing these advanced heuristics, the thought assessor 214 provides a robust assessment of the generated response's confidence, ensuring that only accurate and consistent information is delivered to the user. This confidence evaluation mechanism enables the chatbot to provide prompt responses when certainty is high while deferring to expert oversight in uncertain cases.

In an alternative embodiment, the thought assessor 214 employs a heuristic aggregation approach to compute an overall confidence score for the generated response. This process involves combining the results from various heuristics, each contributing to the final score based on its assigned weight. These weights can be adjusted to align with the desired balance between false positives and false negatives. Once the overall confidence score is calculated, it is compared against a predetermined threshold. If the confidence score exceeds the threshold, the response is deemed reliable and is promptly returned to the user. This ensures that the chatbot can provide quick and accurate responses when the model's certainty is high. However, if the confidence score falls below the threshold, the response is flagged for potential hallucinations. In such cases, the response may undergo further review, possibly involving expert intervention or additional analysis using more resource-intensive models. This approach allows the system to maintain a high standard of reliability and accuracy, ensuring that only trustworthy information is delivered to the user while deferring to expert oversight when uncertainty is detected.

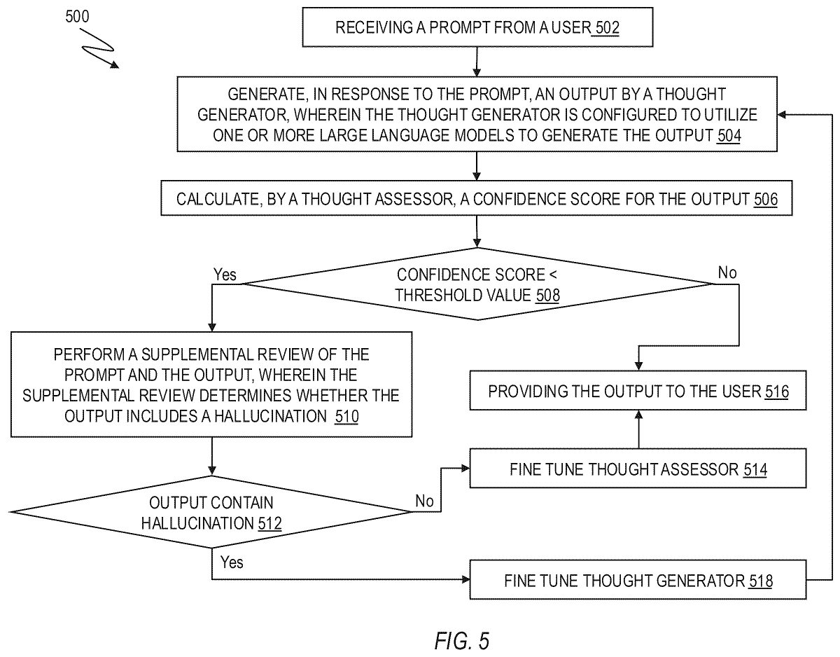

Referring now to FIG. 5, a flow chart illustrating a method 500 for mitigating hallucinations in AI chatbots according to one or more embodiments is shown. The method 500 can be implemented by an AI chatbot system 210, such as the one shown in FIG. 2. The method 500 for mitigating hallucinations begins at block 502 by receiving a prompt from a user. This prompt serves as the initial input to the system, establishing the context for the subsequent operations and guiding the response generation process.

Next, as shown at block 504, the method 500 includes generating, in response to the prompt, an output by a thought generator. The thought generator is configured to utilize one or more large language models to generate the output. This step leverages the capabilities of the thought generator to interpret the user's prompt and produce a coherent response, drawing on its training in relevant domains. Following this, at block 506, the method 500 involves calculating, by a thought assessor, a confidence score for the output. This step marks the transition from response generation to evaluation, where the thought assessor applies various heuristics to assess the accuracy and consistency of the generated output. The confidence score serves as an indicator of the reliability of the response.

Next, as shown at decision block 508, the method 500 determines whether the confidence score is below a threshold value. If the confidence score is below the threshold, the method proceeds to block 510, where a supplemental review of the prompt and the output is performed. This review determines whether the output includes a hallucination, ensuring that any potential inaccuracies are identified and addressed. If the supplemental review at block 510 confirms that the output contains a hallucination, the method 500 proceeds to block 518, where the thought generator is fine-tuned to reduce the likelihood of similar errors in future interactions. Conversely, if the output does not contain a hallucination, the method proceeds to block 514, where the thought assessor is fine-tuned to enhance its sensitivity to such errors. If the confidence score is above the threshold, the method 500 proceeds to block 516, where the output is provided to the user. This ensures that only reliable and accurate information is delivered, maintaining the trustworthiness of the AI chatbot system.

In one embodiment, the thought assessor is configured to utilize a combination of machine learning models, such as neural networks and decision trees, to evaluate the output generated by the thought generator. This configuration allows the thought assessor to leverage the strengths of different model architectures, enhancing the ability to detect hallucinations. In another embodiment, the thought assessor employs a rule-based system that incorporates domain-specific knowledge, such as medical guidelines and protocols, to assess the validity of the output. This approach ensures that the thought assessor can quickly identify outputs that deviate from established medical standards. Additionally, the thought assessor may be implemented as a distributed system, where multiple instances of the assessor operate in parallel to handle high volumes of data, thereby improving the system's scalability and response time. In yet another embodiment, the thought assessor is integrated with a feedback loop mechanism that continuously updates evaluation criteria based on real-time user interactions and expert reviews, allowing adaptation to evolving medical knowledge and user expectations.

In one embodiment, the system employs reinforcement learning techniques to fine-tune the thought generator by utilizing a reward-based mechanism that evaluates the accuracy and relevance of the generated outputs. This approach can be implemented in various configurations, such as using a single-agent reinforcement learning model where the thought generator is treated as an autonomous agent that learns from interactions with the environment, which includes user feedback and expert evaluations. In another embodiment, a multi-agent reinforcement learning framework is utilized, where multiple thought generators operate in parallel, each specializing in different medical domains or types of queries. These agents can share insights and learning experiences to collectively enhance their performance. Additionally, the reinforcement learning process can be adapted to incorporate different types of feedback, such as explicit corrections from medical professionals or implicit feedback derived from user engagement metrics, like response time and satisfaction ratings. The system can also vary the frequency and granularity of the fine-tuning process, ranging from real-time adjustments during active sessions to periodic updates based on accumulated data. Furthermore, the reinforcement learning algorithms can be configured to prioritize certain types of errors or hallucinations, allowing the system to focus on reducing the most significant inaccuracies first. This adaptability ensures that the thought generator continuously evolves to provide more accurate and reliable outputs in diverse medical contexts.

In one embodiment, the system for fine-tuning the thought generator employs reinforcement learning techniques that utilize historical data from previous interactions to iteratively enhance the performance of the thought generator. This embodiment can be implemented in various configurations, such as using a single large language model or an ensemble of models, each trained on different datasets to capture a wide range of medical knowledge and conversational nuances. In another embodiment, the reinforcement learning process is augmented with human-in-the-loop feedback, where medical experts periodically review and provide corrections to the outputs generated by the thought generator. This feedback is then used to adjust the model's parameters, ensuring that the system remains aligned with current medical guidelines and practices. Additionally, the system can be configured to operate in different environments, such as cloud-based platforms for scalability or on-premises installations for enhanced data privacy and security. The adaptability of the system allows the system to be tailored to specific medical domains, such as cardiology or endocrinology, by incorporating domain-specific knowledge bases and heuristics into the reinforcement learning framework.

In exemplary embodiments, the threshold value used for evaluating the confidence score of the output generated by the thought generator can be dynamically adapted over time based on expert or human feedback. This adaptive mechanism ensures that the AI chatbot system remains responsive to evolving standards of accuracy and reliability, particularly in sensitive domains such as medical dialogue. Initially, a predetermined threshold value is set for the confidence score, which serves as a baseline for determining whether the generated output is reliable enough to be presented to the user. This threshold is established based on initial testing and validation of the system's performance across various scenarios. As the AI chatbot system interacts with users and experts, feedback is continuously collected regarding the accuracy and reliability of the responses. This feedback is analyzed to identify patterns or trends in the system's performance, particularly in cases where the confidence score was either too lenient or too stringent in flagging potential hallucinations.

In exemplary embodiments, steering system aggregates feedback from multiple interactions and uses statistical analysis to assess the distribution of confidence scores associated with both accurate and inaccurate outputs. By comparing these distributions, the steering system can identify whether the current threshold value is optimally set to balance the trade-off between false positives (flagging accurate responses as hallucinations) and false negatives (failing to flag hallucinations). Based on this analysis, the steering system can adjust the threshold value to better align with the desired level of accuracy. For instance, if expert feedback indicates that the system is frequently missing hallucinations, the threshold can be lowered to increase sensitivity. Conversely, if the system is overly cautious and frequently flags accurate responses, the threshold can be raised to reduce unnecessary interventions. This adaptive threshold mechanism is further refined through iterative cycles of feedback and adjustment. The steering system may employ machine learning techniques to model the relationship between feedback and threshold adjustments, enabling it to predict optimal threshold settings under varying conditions. Additionally, the system can incorporate domain-specific knowledge, such as medical guidelines, to inform threshold adjustments in context-sensitive scenarios. By continuously adapting the threshold value based on expert and human feedback, the AI chatbot system enhances its ability to provide accurate and reliable responses, thereby increasing user trust and satisfaction. This dynamic approach ensures that the system remains robust and effective in delivering high-quality information, even as the underlying models and external standards evolve over time.

Although primarily described herein as being used in an AI chatbot, the methods disclosed herein can also be used in other AI systems. For example, in the context of knowledge summarization, the disclosed system can be employed to generate concise summaries from a set of documents on a specific topic. The process begins with the thought generator, which is tasked with producing a summary by synthesizing information from the provided documents. This summary aims to capture the essential points and insights from the source material. Once the thought generator produces the summary, the thought assessor evaluates it against the original documents. This evaluation involves checking for accuracy, consistency, and completeness, ensuring that the summary faithfully represents the source material. The thought assessor uses various heuristics to identify potential hallucinations or inaccuracies within the summary. Sentences or sections that exhibit low confidence are flagged for further review. These flagged portions of the summary are then presented to a human editor for verification and correction. The human editor reviews the low-confidence sentences, comparing them with the source documents to ensure factual accuracy and coherence. Any necessary revisions are made to align the summary more closely with the original content.

In exemplary embodiments, the thought assessor is configured to evaluate the output generated by the thought generator by leveraging not only the final output but also the internal states of the model. These internal states include, but are not limited to, attention weights, hidden states, and other intermediate representations that provide insight into the model's decision-making process. The attention weights indicate the focus of the model on different parts of the input prompt and context documents during the generation process. By analyzing these weights, the thought assessor can identify which tokens or phrases the model considered most relevant when forming the response. This analysis helps in detecting potential contradictions or inconsistencies in the generated output. Hidden states, on the other hand, reflect the intermediate representations within the model that capture the contextual information and semantic understanding of the input. These states offer a deeper layer of analysis into the model's internal processing and decision-making. By examining the hidden states, the thought assessor can gain a more comprehensive understanding of the model's confidence in its predictions and identify any underlying uncertainties that may not be apparent from the final output alone. By incorporating these internal states into its evaluation process, the thought assessor can apply a more nuanced and robust set of heuristics to calculate a confidence score for the generated response. This approach ensures that the ai system delivers accurate and reliable responses to the user by identifying potential hallucinations or inaccuracies at an earlier stage in the generation process.

In exemplary embodiments, the AI chatbot system employs a simulated training method using patient and doctor agents to enhance the performance of the AI chatbot system. This approach leverages the unique capabilities of the multi-agent architecture to create a robust and comprehensive development environment for medical dialogue systems. In exemplary embodiments, the simulation setup involves creating a patient agent that simulates responses based on medical records and interactions, encompassing a wide range of possible scenarios. The patient agent is designed with hidden states representing underlying diseases or conditions, which are not initially visible to the doctor agent. These hidden states serve as ground truth for evaluating the chatbot's performance and guiding the self-supervised learning process. In exemplary embodiments, the doctor agent interacts with the patient agent, conducting probes and tests to diagnose and treat the simulated patient. Through these interactions, the doctor agent attempts to uncover the hidden states of the patient agent, thereby simulating real-world medical diagnostic and treatment processes. In exemplary embodiments, the synthetic dataset generated from these simulated interactions is used to train and test the medical chatbot, which plays the role of the doctor agent. A loss and reward system is implemented to evaluate the chatbot's performance, focusing on minimizing hallucinations and providing accurate, effective responses. The success of the interactions is judged by the improvement in the patient agent's hidden state, ensuring that the training focuses on optimal medical decision-making. By incorporating this simulation methodology, the system enables self-supervised learning, allowing the AI chatbot to refine its ability to provide accurate medical advice while minimizing hallucinations. This iterative process fosters continuous improvement, ensuring that the chatbot delivers increasingly reliable and safe information in diverse medical scenarios.

While the foregoing is directed to embodiments of the present disclosure, other and further embodiments of the present disclosure may be devised without departing from the basic scope thereof, and the scope thereof is determined by the claims that follow.

What is claimed is:

1. A computer-implemented method for mitigating hallucinations in artificial intelligence chatbots, the method comprising:
receiving a prompt from a user;
generating, in response to the prompt, an output by a thought generator, wherein the thought generator is configured to utilize one or more large language models to generate the output;
calculating, by a thought assessor, a confidence score for the output;
based on a determination that the confidence score of the output does not exceed a threshold value, performing a supplemental review of the prompt and the output, wherein the supplemental review determines whether the output includes a hallucination; and
based on a determination that the output includes the hallucination, fine-tuning the thought generator.

2. The computer-implemented method of claim 1, further comprising providing the output to the user based on a determination that the confidence score of the output exceeds the threshold value.

3. The computer-implemented method of claim 1, further comprising fine-tuning the thought assessor based on a determination that the output does not include the hallucination.

4. The computer-implemented method of claim 3, wherein fine-tuning the thought generator includes reinforcement learning techniques to iteratively improve a performance of the thought generator based on historical data.

5. The computer-implemented method of claim 1, wherein the supplemental review of the prompt and the output is performed by a specialty LLM.

6. The computer-implemented method of claim 1, wherein the thought assessor utilizes multiple heuristics, including sequence log-probability, attention to contradictory tokens, and dissimilarity of Monte Carlo samples, to calculate the confidence score.

7. The computer-implemented method of claim 1, wherein fine-tuning the thought generator includes reinforcement learning techniques to iteratively improve a performance of the thought generator based on historical data.

8. The computer-implemented method of claim 1, wherein the thought assessor is further configured to calculate the confidence score based on one or more internal states of the model of the thought generator when the output is generated.

9. The computer-implemented method of claim 8, wherein the one or more internal states include attention weights, hidden states, and other intermediate representations.

10. The computer-implemented method of claim 1, wherein the supplemental review of the prompt and the output is performed by a steering system.

11. The computer-implemented method of claim 10, wherein the steering system is configured to incorporate human feedback to iteratively refine both the thought generator and the thought assessor.

12. A system comprising:
a memory comprising computer readable instructions; and
a processing device for executing the computer readable instructions, the computer readable instructions controlling the processing device to perform operations comprising:
receiving a prompt from a user;
generating, in response to the prompt, an output by a thought generator, wherein the thought generator is configured to utilize one or more large language models to generate the output;
calculating, by a thought assessor, a confidence score for the output;
based on a determination that the confidence score of the output does not exceed a threshold value, performing a supplemental review of the prompt and the output, wherein the supplemental review determines whether the output includes a hallucination; and
based on a determination that the output includes the hallucination, fine-tuning the thought generator.

13. The system of claim 12, wherein the operations further comprise providing the output to the user based on a determination that the confidence score of the output exceeds the threshold value.

14. The system of claim 12, wherein the operations further comprise fine-tuning the thought assessor based on a determination that the output does not include the hallucination.

15. The system of claim 14, wherein fine-tuning the thought generator includes reinforcement learning techniques to iteratively improve a performance of the thought generator based on historical data.

16. The system of claim 12, wherein the supplemental review of the prompt and the output is performed by a specialty LLM.

17. The system of claim 12, wherein the thought assessor utilizes multiple heuristics, including sequence log-probability, attention to contradictory tokens, and dissimilarity of Monte Carlo samples, to calculate the confidence score.

18. The system of claim 12, wherein fine-tuning the thought generator includes reinforcement learning techniques to iteratively improve a performance of the thought generator based on historical data.

19. The system of claim 12, wherein the thought assessor is further configured to calculate the confidence score based on one or more internal states of the model of the thought generator when the output is generated.

20. A computer program product for performing self-health checks in monitoring products, the computer program product comprising:
a set of one or more computer-readable storage media;
program instructions, collectively stored in the set of one or more storage media, for causing a processor set to perform the following computer operations:
receiving a prompt from a user;
generating, in response to the prompt, an output by a thought generator, wherein the thought generator is configured to utilize one or more large language models to generate the output;
calculating, by a thought assessor, a confidence score for the output;
based on a determination that the confidence score of the output does not exceed a threshold value, performing a supplemental review of the prompt and the output, wherein the supplemental review determines whether the output includes a hallucination; and
based on a determination that the output includes the hallucination, fine-tuning the thought generator.
